(19) United States
(12) Patent Application Publication
(10) Pub. No.: US 2017/0335563 A1
(43) Pub. Date: Nov. 23, 2017

(54) INSULATION DEVICES INCLUDING VACUUM-INSULATED CAPSULES

(71) Applicant: FIRESTONE BUILDING PRODUCTS CO., LLC, Indianapolis, IN (US)

(72) Inventors: Michael J. HUBBARD, Anderson, IN (US); Chunhua YAO, Carmel, IN (US); Brian ALEXANDER, Westfield, IN (US); John LETTS, Carmel, IN (US)

(73) Assignee: FIRESTONE BUILDING PRODUCTS CO., LLC, Indianapolis, IN (US)

(21) Appl. No.: 15/523,130

(22) PCT Filed: Oct. 30, 2015
(86) PCT No.: PCT/US2015/058352

§ 371 Date: Apr. 28, 2017

Related U.S. Application Data
(60) Provisional application No. 62/073,447, filed on Oct. 31, 2014.

(51) Int. Cl. E04B 1/80; B32B 5/18; B32B 3/06; B32B 27/06; B32B 27/30; B32B 27/40

(52) U.S. Cl. CPC E04B 1/803; B32B 27/302; B32B 27/40; B32B 3/06; B32B 27/065; B32B 5/18; B32B 2607/00

(57) ABSTRACT

An insulation device comprising a first plurality of vacuum-insulated capsules connected along a first plane, where each vacuum-insulated capsule within said first plurality has a common first geometric shape extending from the first plane and a second plurality of vacuum-insulated capsules connected along a second plane, where each vacuum-insulated capsule within said second plurality has a common second geometric shape extending from the second plane, where said first and said second geometric shapes are complementary, and where said first plurality of vacuum-insulated capsules are intermeshed within said second plurality of vacuum-insulated capsules to form the insulation device.

This application claims the benefit of U.S. Provisional Patent Application Ser. No. 62/073,447, filed on Oct. 31, 2014, which is incorporated herein by reference.

### FIELD OF THE INVENTION

Embodiments of the present invention are directed toward insulation devices that include a plurality of vacuum-insulated capsules.

### BACKGROUND OF THE INVENTION

Vacuum-insulated panels (VIPs) are known. Generally, these panels include a gas-tight enclosure that encapsulates a rigid core that has been air evacuated. The enclosure is typically made of a membrane that prevents the passage of air, and the rigid core is typically a highly-porous material that supports the enclosing membrane against atmospheric pressure once the air is evacuated. Since VIPs prevent the transfer of heat based upon a vacuum, they are very efficient and therefore highly desirable.

While desirable, VIPs can be difficult to install since their size is not easily manipulated once the panel is constructed. This is in sharp contrast to many other insulation devices, such as rolled insulation or insulation board, which can be easily cut and shaped to meet configurational demands related to installation. If one attempts to alter the dimensions of a VIP, such as by cutting the length and/or width of the VIP, the vacuum seal is lost thereby destroying the insulating properties of the VIP.

Likewise, the ability to secure a VIP into its desired location of use is limited. Indeed, in many situations it is desirable to fasten an insulating device to a building structure. For example, insulation boards are often secured to a roof surface by using mechanical fasteners such as nails and the like. VIPs cannot be secured in this fashion since any mechanical fastener that would pierce the vacuum-sealed enclosure would destroy the evacuated chamber and thereby destroy the insulating properties of the board.

### SUMMARY OF THE INVENTION

One or more embodiments of the present invention provide an insulation device comprising a first plurality of vacuum-insulated capsules connected along a first plane, where each vacuum-insulated capsule within said first plurality has a common first geometric shape extending from the first plane and a second plurality of vacuum-insulated capsules connected along a second plane, where each vacuum-insulated capsule within said second plurality has a common second geometric shape extending from the second plane, where said first and said second geometric shapes are complementary, and where said first plurality of vacuum-insulated capsules are intermeshed within said second plurality of vacuum-insulated capsules to form the insulation device.

### BRIEF DESCRIPTION OF THE DRAWINGS

FIG. 1A is a cross-sectional side view of an insulating device according to embodiments of the invention.

FIG. 1B is a cross-sectional side view of the upper portion of the insulating device shown in FIG. 1A.

FIG. 1C is a cross-sectional side view of the lower portion of the insulating device shown in FIG. 1A.

FIG. 2A is a cross-sectional side view of an insulating device according to embodiments of the invention.

FIG. 2B is a cross-sectional side view of the upper portion of the insulating device shown in FIG. 2A.

FIG. 2C is a cross-sectional side view of the lower portion of the insulating device shown in FIG. 2A.

FIG. 3A is a cross-sectional side view of an insulating device according to embodiments of the invention.

FIG. 3B is a cross-sectional side view of the upper portion of the insulating device shown in FIG. 3A.

FIG. 3C is a cross-sectional side view of the lower portion of the insulating device shown in FIG. 3A.

FIG. 4 is an overhead plan view of an insulating device according to embodiments of the present invention.

FIG. 5 is an overhead plan view of an insulating device according to embodiments of the present invention.

FIG. 6 is a cross-sectional view of a vacuum-insulated capsule according to embodiments of the invention.

FIG. 7 is a cross-sectional view of an encapsulated insulating device according to embodiments of the invention.

### DETAILED DESCRIPTION OF ILLUSTRATIVE EMBODIMENTS

Embodiments of the invention are based, at least in part, on the discovery of an insulating device including a plurality of first and second planarly arranged vacuum-insulated capsules intermeshed with each other. As a result of this assembly, the insulating devices of the present invention can be cut to a desire width or length without having an appreciable impact on the insulating properties of the insulating device. Likewise, the insulating devices of the present invention can advantageously be mechanically fastened to a building structure without having an appreciable impact on the insulating properties of the overall insulating device. Additionally, the intermeshed plurality of insulating capsules can be encased within a protective material such as foam.

### Insulating Device Configuration

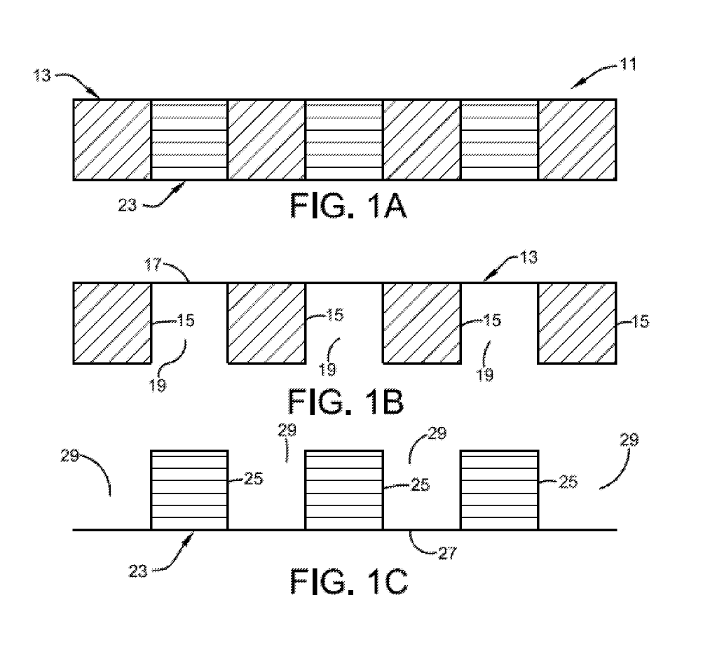

Devices of the invention can be described with reference to the drawings. For example, FIG. 1A shows insulating device 11 including upper portion 13 intermeshed with lower portion 23. FIG. 1B shows upper portion 13 separated from lower portion 23. As best shown in FIG. 1B, upper portion 13 includes an upper plurality of vacuum-insulated capsules 15, which are connected along a common plane by upper substrate 17. A plurality of interstices 19 exist between the respective vacuum-insulated capsules 15. FIG. 1C shows lower portion 23 including a lower plurality of vacuum-insulated capsules 25, which are connected along a common plane by lower substrate 27. A plurality of interstices 29 (or open spaces 29) exist between the respective vacuum-insulated capsules 25. As should be evident from FIGS. 1A-1C, upper plurality of vacuum-insulated capsules 15 are geometrically shaped to complement the geometric shapes of lower plurality of vacuum-insulated capsules 25 so that upon being intermeshed, interstices 19 are at least partially occupied by lower plurality of vacuum-insulated capsules 25, and interstices 29 are at least partially occupied by upper plurality of capsules 15. In this manner, the percentage of the volume of insulating device 11 occupied by vacuum-insulated capsules 15, 25 is maximized.

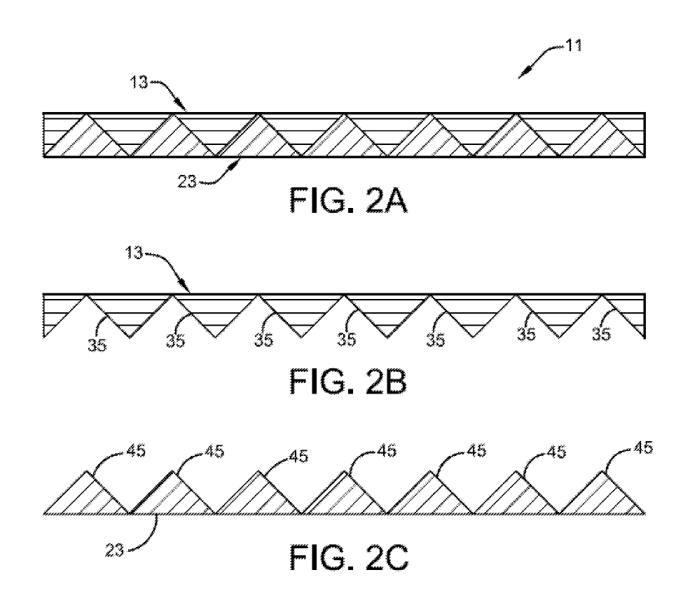

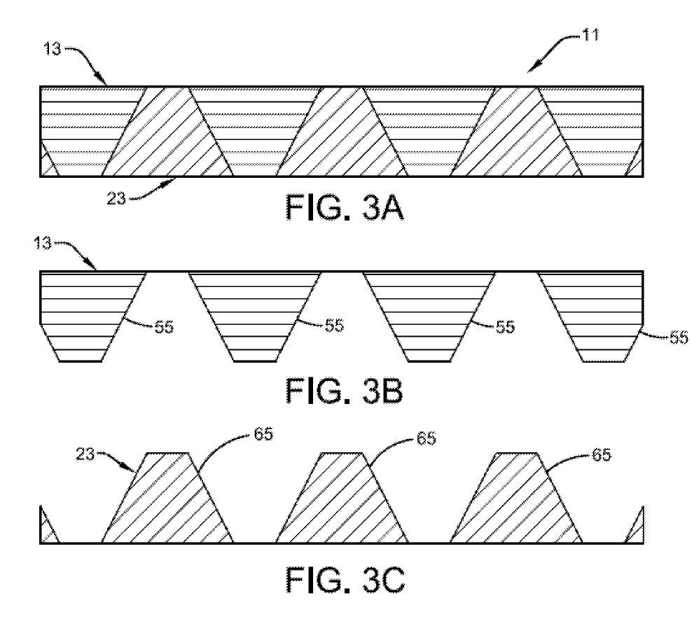

With reference again to FIGS. 1A-1C, the geometric shape of the respective vacuum-insulated capsules (15 and 25) as shown is cubical. As a result, the geometric shape of the respective interstices (19 and 29) is likewise cubical. The vacuum-insulated capsules can also be configured into other shapes. For example, as shown in FIGS. 2A-2C, vacuum-insulated capsules 35, 45 (upper and lower) are pyramidal. Or, as shown in FIGS. 3A-3C, vacuum-insulated capsules 55, 65 (upper and lower) are frustopyramidal. In yet other embodiments, the capsules may be configured into prisms including rectangular prisms and triangular prisms.

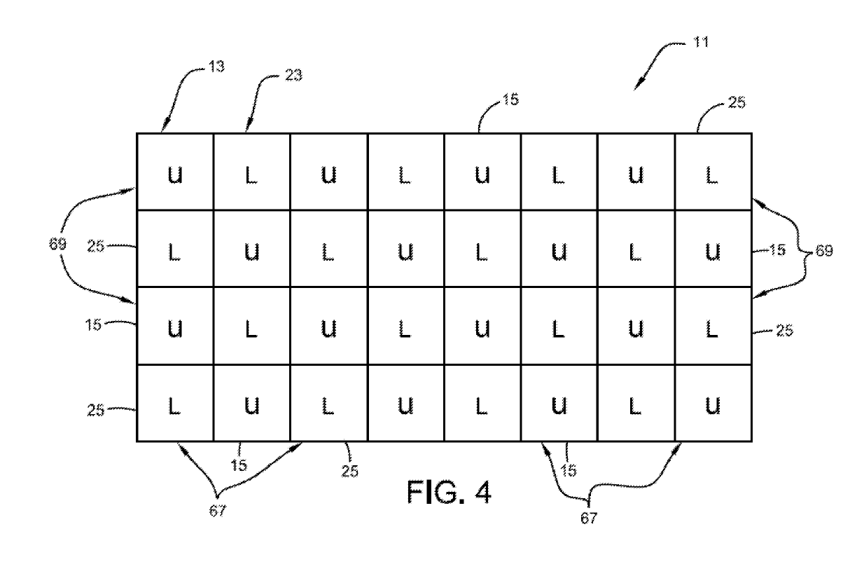

While FIGS. 1A-1C, as well as FIGS. 2A-2C and 3A-3C, are shown two-dimensionally, it should be understood that the pattern of vacuum-insulated capsules and interstices extend in both the width and length direction of the device. Thus, as shown in FIG. 4, once upper portion 13 and lower portion 23 are intermeshed (i.e. matingly engaged in alternating fashion), the resulting insulating device (i.e. device 11) will include alternating capsules 15, 25 from upper portion 13 (designated U) and lower portion 23 (designated L). As also shown in FIG. 4, the intermeshing of lower portion 13 and upper portion 23 provides multiple rows 67 and columns 69 of capsules 15, 25. Stated another way, the overall devices (i.e. insulating device 11) of the invention, which devices may be generally planar in overall configuration, include multiple vacuum-insulated capsules in both the width and length dimensions of the device. In one or more embodiments, the insulating devices of the present invention include a first plurality of vacuum-insulated capsules that are arranged in two or more columns and two or more rows. In one or more embodiments, these capsules are interconnected through a common substrate. In these or other embodiments, the devices include a second plurality of vacuum-insulated capsules that are arranged in two or more columns and two or more rows. In one or more embodiments, these second plurality of vacuum-insulated capsules are interconnected through a common substrate.

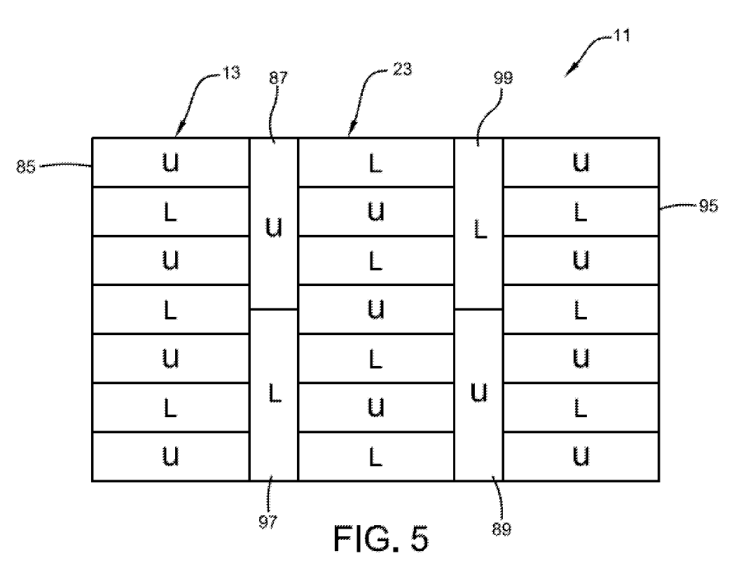

In one or more embodiments, the components of the upper and lower portions need not be symmetrical. For example, as shown in FIG. 5, device 11 includes upper portion 13 and lower portion 23 intermeshed as with previous embodiments. Capsules 85, 95 (85 being contributed by lower portion 13 and designated U, and 95 being contributed by upper portion 23 and being designated L) are shaped as rectangular prisms. Additionally, each capsule is not symmetrical in that the capsules 87, 89, which belong to lower portion 13, are perpendicular to capsules 85. Similarly, capsules 97, 99, which belong to lower portion 23, are perpendicular to capsules 95. In particular embodiments, capsules 87, 89, as well as capsules 97, 99, are separate and apart from lower 13 and upper portion 23. Instead, capsules 87, 89, as well as capsules 97, 99, are contributed by additional portions. Stated another way, one or more capsules within the intermeshed network of capsules may be contributed to the overall network through sources other than lower portion 13 and upper portion 23.

### Vacuum-Insulated Capsules

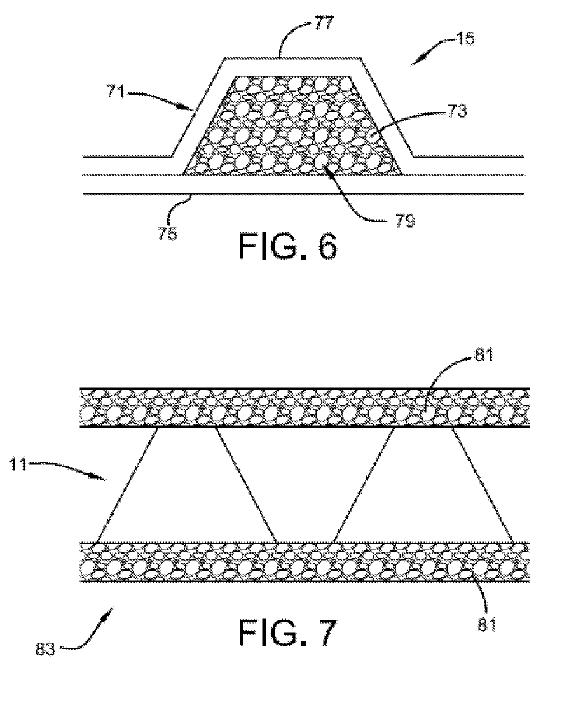

Practice of the present invention is not necessarily limited by the construction of the various vacuum-insulated capsules. Indeed, the skilled person can fabricate the vacuum-insulated capsules by using various known techniques. And, once the teachings of this invention are understood, the known techniques can be applied to create the devices of this invention. In one or more embodiments, the vacuum-insulated capsules can be manufactured from materials known for preparing vacuum-insulated panels. For example, and as shown in FIG. 6, vacuum-insulated capsule 15 includes encapsulating element 71, which may also be referred to as membrane 71, which surrounds and encapsulates rigid element 73, which may also be referred to as core 73. Encapsulating element 71 may include substrate portion 75, which may also be referred to as base 75, and surrounding portion 77, which may also be referred to shroud 77. In one or more embodiments, surrounding portion 77 is sealed to base portion 75 to form an encasement or chamber 79 around core 73 that is impervious or substantially impervious to air. Upon evacuating chamber 79, the overall geometric shape of vacuum-insulated capsule 15 takes on the geometric shape of core 73. Thus, it should be understood that each vacuum-insulated capsule 15 is a self-contained unit with respect to its insulating properties. As a result, if the insulating properties of any vacuum-insulated capsule is compromised, this will not necessarily lead to the compromise of any adjacent vacuum-insulated capsules within a particular device.

In one or more embodiments, core 73 may include a rigid, highly-porous material that supports the membrane walls against atmospheric pressure once the air is evacuated. In one or more embodiments, examples of vacuum insulated panels include silica (e.g., fumed or precipitated silica), alumina, titania, magnesia, chromia, tin dioxide, glass wool, fiberglass, carbon, aluminosilicates (e.g., perlite), open-cell polystyrene, or open cell polyurethane. In these or other embodiments, core 73 may include an aerogel such as carbon aerogels, silica aerogels, and alumina aerogels. Other examples of materials that are suitable for forming a core are known in the art as disclosed in U.S. Pat. Publ. Nos. 2013/0216854, 2013/0216791, 2013/0142972, 2013/0139948, 2012/0009376, 2009/0126600, 2008/0236052, 2004/0058119, 2003/0159404, and 2003/0082357 which are incorporated herein by reference.

In one or more embodiments, membrane 71 may include a material that is impervious or substantially impervious to the transmission or diffusion of air. For example, membrane 71, or at least a portion thereof, may include metal foil, such as aluminum foil. In these or other embodiments, membrane 71 may include a polymeric film such as, but not limited to, a multi-layered film including one or more polymeric layers designed to prevent or at least inhibit the transmission or diffusion of air. In particular embodiments, portions of membrane 71, such as base 75, may be fabricated from a first material, such as foil, and other portions, such as shroud 77, may be fabricated from a second material, such a polymeric film.

The individual vacuum-insulated capsules of the devices of the present invention are advantageously small, especially with respect to the width and length of the overall device. As the skilled person will recognize, this allows the device to be sized or secured using mechanical fasters while only destroying a minimal portion of the devices insulating properties. The size of the individual capsules can be described with reference to the inner volume of the capsule, which is, in most embodiments, proximate in volume to the volume of the core. In or more embodiments, the volume of the individual capsules is at most 16 cubic inches (0.262 liter), in other embodiments at most 12 cubic inches (0.0197 liter), in other embodiments at most 8 cubic inches (0.131 liter), in other embodiments at most 4 cubic inches (0.066 liter), in other embodiments at most 2 cubic inches (0.033 liter), and in other embodiments at most 1 cubic inches (0.016 liter). In these or other embodiments, the volume of the individual capsules is at least 0.1 cubic inches (0.0016 liter), in other embodiments at least 0.3 cubic inches (0.0049 liter), in other embodiments at least 0.5 cubic inches (0.0082 liter), in other embodiments at least 0.7 (0.0115 liter), in other embodiments at least 1 cubic inches (0.016 liter), and in other embodiments at least 2 cubic inches (0.033 liter). In one or more embodiments, the volume of the individual capsules is from about 0.1 cubic inches (0.0016 liter) to about 16 cubic inches (0.262 liter), in other embodiments from about 0.3 cubic inches (0.0049 liter) to about 12 cubic inches (0.0197 liter), and in other embodiments from about 0.5 cubic inches (0.0082 liter) to about 8 cubic inches (0.131 liter).

### Encapsulated Device

As suggested above, in one or more embodiments, the insulating device described above may be encased within a protective fortification or shield. For example, in one or more embodiments, and as shown in FIG. 7, insulating device 11 can be encapsulated within an insulating material 81, such as insulating foam, to thereby form encapsulated device 83. Examples of insulating foams that can be used to encapsulate insulating device 11 include foamed polystyrene, such as expanded polystyrene, and polyurethane and/or polyisocyanurate foam. Exemplary technology for encapsulating an insulating device is disclosed in PCT/US2015/153568, which is incorporated herein by reference.

### INDUSTRIAL APPLICABILITY

In one more embodiments, the insulating devices of the invention can be fabricated into insulating devices for use in the construction industry. For example, the insulating devices can be fabricated into construction boards that can be used as insulating devices for roof and wall applications. Thus, embodiments of the present invention are directed toward a building structure having the insulation devices of this invention. In one or more embodiments, the insulation devices of this invention are mechanically attached to the building structure by using one or more known mechanical fasteners, such as nails or screws. In one or more embodiments, the insulating devices are mechanically attached to the building structure by piercing one or more of the vacuum-insulated capsules with one or more of the mechanical fasteners. As suggested above, while piercing these vacuum-insulated capsules will have a detrimental impact on the insulating properties of the particular capsules, the fact that any individual capsule contributes only a fraction of the overall insulating properties of the overall device allows the overall device to maintain its insulating properties while being mechanically attached to the building structure.

In one or more embodiments, the insulating devices are fabricated into construction boards having a thickness of from about 0.25 inch (0.635 cm) to about 12 inches (30.48 cm), in other embodiments from about 0.5 inch (1.27 cm) to about 10 inches (25.4 cm), in other embodiments from about 1 inch (2.54 cm) to about 6 inches (15.24 cm), and in other embodiments from about 2 inches (5.08 cm) to about 4 inches (10.16 cm). In these or other embodiments, the construction boards can have a width of from about 14 inches (35.56 cm) to 10 feet (3.048 m), in other embodiments from about 1 foot (0.3048 m) to about 8 feet (2.4384 m), and in other embodiments from about 2 feet (0.6096 m) to about 6 feet (1.8288 m). In these or other embodiments, the construction board can have a length of from about 4 feet (1.2192 m) to about 20 feet (6.096 m), in other embodiments from about 6 feet (1.8288 m) to about 18 feet (5.4864 m), and in other embodiments from about 8 (2.4384 m) to about 14 feet (4.2672 m).

Various modifications and alterations that do not depart from the scope and spirit of this invention will become apparent to those skilled in the art. This invention is not to be duly limited to the illustrative embodiments set forth herein.

1. An encapsulated insulation device comprising:
i. a first plurality of vacuum-insulated capsules connected along a first plane, where each vacuum-insulated capsule within said first plurality has a common first geometric shape extending from the first plane; and
ii. a second plurality of vacuum-insulated capsules connected along a second plane, where each vacuum-insulated capsule within said second plurality has a common second geometric shape extending from the second plane, where said first and said second geometric shapes are complementary, and where said first plurality of vacuum-insulated capsules are intermeshed within said second plurality of vacuum-insulated capsules to form the insulation device; and
iii. an insulating material encapsulating the insulation device to form the encapsulated insulation device.

2. The encapsulated insulation device of claim 1, where the insulation device includes first and second opposed planar surfaces, and where said first plane forms at least a portion of said first planar surface and where said second plane forms at least a portion of said second planar surface.

3. The encapsulated insulation device claim 1, where said first and second geometric shapes are the same.

4. The encapsulated insulation device of claim 1, where said insulation device is in the form of a board having a thickness of from about 0.5 to about 6 inches, a width of from about 2 to about 8 feet, and a length of from about 6 to about 14 feet.

5. The encapsulated insulation device of claim 1, where said first and second geometric shapes are cubes.

6. The encapsulated insulation device of claim 1, where said first and second geometric shapes are rectangular prisms.

7. The encapsulated insulation device of claim 1, where said first and second geometric shapes are triangular prisms.

8. The encapsulated insulation device of claim 1, where said first and second geometric shapes are prisms.

9. The encapsulated insulation device of claim 1, where said first and second geometric shapes are pyramids.

10. The encapsulated insulation device of claim 1, where said first and second geometric shapes are frustopyramids.

11. The encapsulated insulation device of claim 1, where said first plurality of vacuum-insulated capsules are arranged into two or more columns and two or more rows, and where said second plurality of vacuum-insulated capsules are arranged into two or more columns and two or more rows.

12. The encapsulated insulation device of claim 1, where each of said first plurality of vacuum-insulated capsules and said second plurality of vacuum-insulated capsules are self-contained.

13. The encapsulated insulation device of claim 1, wherein the insulating material is an insulating foam selected from the group consisting of polystyrene, polyurethane, polyisocyanurate, and combinations thereof.

14. The encapsulated insulation device of claim 1, wherein the insulating material is applied to both the first and second opposed planar surfaces of the insulation device.
